(19) United States
(12) Patent Application Publication
(10) Pub. No.: US 2008/0190326 A1
(43) Pub. Date: Aug. 14, 2008

(54) MID TEMPERATURE AND AMBIENT TEMPERATURE APPLIED ASPHALT COMPOSITIONS

(76) Inventor: JOHN R. FIELDS, KENT, WA (US)

Correspondence Address: TORYS LLP, 79 WELLINGTON ST. WEST, SUITE 3000, TORONTO, ON, M5K 1N2, omitted

(21) Appl. No.: 11/673,197

(22) Filed: Feb. 9, 2007

(51) Int. Cl. C04B 24/00; C04B 24/08

(52) U.S. Cl. 106/665; 106/807

(57) ABSTRACT

Improved asphalt compositions and methods of preparing them. Methods according to the invention include mixing asphalt with lube stock and optionally with a gelling agent, surfactant and fillers. Fibers may, for example, include cellulose fibers, polyolefin fibers, and mineral wool. Inventive compositions provide viscosities suitable for ambient temperature applications as well as mid-temperature applications within the range of 150-275 F.

### BACKGROUND OF THE INVENTION

The invention relates to new asphalt compositions. In particular the invention relates to mid-temperature applied asphalt compositions and ambient temperature applied asphalt compositions, for example coatings and mastics, for use in roofing and waterproofing. The asphalt compositions comprise lube-stock grade petroleums (“lube stock”), and can be produced without the use of oxidation and/or mineral spirits.

Asphalt compositions have been used as sealants and paving compounds for thousands of years, on roofs, roads, and in many other applications. Originally asphalts were taken from bituminous deposits in the earth and applied directly. More recently, most asphalts are derived from the distillation of petroleum products, typically being defined as the end residue of the distillation process.

For many years, asphalts were used in the rough forms in which they were found or distilled, without additives or modification. As a result of efforts to address the non-uniform compositions and other undesirable properties such rough asphalts typically exhibit, most current asphalts are modified prior to use.

For example, it is very common to modify asphalts used for any purpose to increase their softening points. Unmodified asphalts typically exhibit softening points in the range of 85-90 degrees Fahrenheit (F). Given that surface temperatures on an asphalt roof or roadway may, under a summer sun, climb well above 200 degrees F., it may be seen that in many applications softening points in the region of 90 degrees F. are unsuitable.

One of the most common means of raising the softening point of asphalts is by oxidation. In a typical oxidation process, asphalt is placed in a large holding tank, or air still, and heated to approximately 500 degrees F. at atmospheric pressure. Air is introduced at the bottom of the tank and allowed to percolate up toward the top of the asphalt creating an exothermic reaction which lengthens molecular bonds between asphalt particles and thus has the effect of raising the softening point of the asphalt. The degree to which the softening point is raised is a function of the amount of oxidation to which the asphalt is subjected.

However, the process of oxidizing asphalt actually degrades the asphalt's waterproofing and weathering ability. To restore these properties in oxidized asphalts, a number of additives have been found to be useful, though none has been ideal and many have introduced other undesirable qualities; and all require added expense and processing to the creation of the asphalt compositions. In addition, the oxidation process is expensive, harmful to the environment, and potentially dangerous to those conducting the process.

Among many known forms of asphalts are hot-temperature applied asphalts, for example hot mopping grade asphalts; and ambient temperature applied asphalts, for example coatings and mastics.

### Hot-Temperature Applied Asphalts

Hot-temperature applied asphalts (including hot-mopping grade asphalts) have been known and used for more than 100 years. Hot-mopping grade asphalts are typically heated at the installation site (or heated off-site and transported to the worksite) to a point at which their viscosity is sufficiently low as to allow them to be spread directly on a roof or other substrate, using a mop, squeegee, or other device. Heretofore, it has been necessary to heat hot-temperature applied asphalt compositions to temperatures of 500 degrees F. or more for application.

The heating of such asphalts to such high temperatures for transportation and application is expensive and extravagantly wasteful of energy resources, produces prodigious amounts of pollutants, and is physically dangerous to those who handle the asphalts or travel the highways and roadways with the heated compositions. The handling of asphalts at such temperatures exacerbates, for example, the many occurrences of accidental burn injuries among workers each year. Even when safely handled, the heating of such compositions results in the release of copious amounts of fumes, odors, and other emissions at thousands of worksites each day.

To avoid the necessity of heating asphalts to such high temperatures for application, several solutions have been offered. For example, asphalt compositions comprising large amounts of mineral spirits or other cutback chemicals have been provided; and aqueous emulsions have been developed. Both cutback and emulsion compositions may be applied at ambient temperatures, without heating, but neither type provides the high-quality adhesion, sealing and waterproofing qualities of hot-temperature applied asphalts. In addition, up to 20% by weight lube stock and other additives have been added to paving asphalts in an effort to prevent cracking at low temperatures (Hayner et al., 1999 U.S. Pat. No. 5,904,760 and U.S. Pat. No. 5,911,817).

Asphalt compositions which do not require oxidation or dangerous and expensive high-temperature heating for transportation and application, and which provide adequate and superior waterproofing, sealing, and weathering qualities, without the use of cutback or emulsifying agents, while providing superior sag resistance and adhesion were described in applicant's previous application, U.S. patent application Ser. No. 10/960,779. These asphalts are suitable for application at temperatures ranging from 250 to 450 degrees Fahrenheit.

### Ambient-Temperature Applied Asphalt Compositions

Ambient-temperature applied asphalt compositions, including for example coatings and mastics, are asphalts primarily used for roofing and waterproofing projects. Such asphalts are formulated for ease of application right, for example, from the can at year-around temperatures. Since outside temperatures may vary significantly, the viscosity of such asphalts can be expected to vary by season and geography; thus manufacturers typically change their viscosity to meet these changing conditions. Therefore, ambient temperature applied asphalt formulas are usually designed to adjust for cold, mild, and hot conditions.

Typically, in producing ambient-temperature applied asphalts, an industrial grade mineral spirit having an open cup test flash point in excess of 100 F degrees has been mixed into an asphalt base stock. The mineral spirits have been used to keep the viscosity of the asphalt low enough, while stored in a can or other closed container, to allow it to be applied to a surface by trowel or by brush after the can or other closed container is opened. Thereafter the mineral spirits, being highly volatile, have evaporated away, leaving behind an asphalt sealant of significantly higher viscosity than when applied.

Because such ambient temperature applied asphalts have had mineral spirits blended into them, they have been referred to as “cut-backs”. Cut-back base stocks have usually been composed of about 60% asphalt and 40% mineral spirits. Such cut-back compositions have been used for many years.

Disadvantages to using mineral spirits to produce trowelable ambient-temperature applied asphalts are at least threefold: (1) the mineral spirits contained in cut-backs are relatively expensive, and are typically the most costly ingredients in the compositions; (2) cut-back mineral spirits usually have a very low flash point of about 105 degrees F., placing them in a highly-combustible category; and (3) the mineral spirits will evaporate into the atmosphere within about 30 days after application, providing no lasting benefit for the asphalt and introducing significant amounts of hydrocarbons into the atmosphere.

The release of hydrocarbons, of which mineral spirits are one type, into the air has been a major target of the Environmental Protection Agency (EPA) to reduce over the past years. It is thought that hydrocarbons released into the atmosphere contribute to ozone layer erosion and global warming due to the “green house” effect.

The ambient-temperature applied asphalt industry, as well as the paint industry and other kindred industries, have come under strict regulations from the EPA to minimize and/or eliminate mineral spirits from their formulations.

Up to now, no one has developed a way to either minimize the use of mineral spirits or to completely eliminate its use in the ambient-temperature applied asphalt industry.

There is a need for mid-temperature applied asphalt compositions which provide waterproofing, sealing and weathering qualities without the use of oxidation.

There is also a need for ambient-temperature applied asphalt compositions made without the use of cutbacks or emulsifying agents, or with reduced or minimal use of cutbacks or emulsifying agents.

### Definitions

Asphalt, for the purposes of this disclosure, and unless clearly indicated otherwise, means any bituminous material or hydrocarbon, with or without additives, fillers, or aggregates, having sufficient insolubility in water and viscosity to be used advantageously in roofing, sealing, paving, or waterproofing, whether naturally occurring or distilled from petroleum or like products. In particular, asphalt includes, without limitation, flux asphalts, raw asphalts, straight-run asphalts or asphalts modified by the addition of rubbers or other polymers, coal, tar, and pitch, as well as bitumens and modified bituminous materials, or any other materials, and whether oxidized or unoxidized.

Hot-temperature applied asphalts are asphalts that require heating in order to be applied. These asphalts are typically heated at the installation site (or heated offsite and transported to the worksite) to a point at which their viscosity is sufficiently low as to allow them to be spread directly on a roof or other substance, using a mop, squeegee, or other device. Traditionally, it has been necessary to heat hot temperature applied asphalts to temperatures of approximately 500 degrees F.

Mid-temperature applied asphalts are new asphalts provided in accordance with the present invention. Mid-temperature applied asphalts can require heating in order to be applied, particularly where it is desired to improve adhesion to substrates such as roofing reinforcement sheets. However, they can be applied at significantly lower temperatures than traditional hot-temperature applied asphalts. Normally, it has been necessary to heat hot-temperature applied asphalts to temperatures of approximately 500 degrees F. Mid-temperature applied asphalts in accordance with the invention can be applied at temperatures of, for example, between about 150 to 275 degrees F.

Ambient-temperature applied asphalts do not need to be heated to be applied. Ambient-temperature applied asphalts can include, for example, coatings and mastics. Such asphalts are formulated for ease of application right from the container at year-round temperatures, without heating. Typically, in producing ambient temperature applied asphalts, an industrial grade mineral spirit having an “open cup test” flash point in excess of 100 degrees F. has been mixed into an asphalt based stock. The mineral spirits have been used to keep the viscosity of the asphalt low enough, while stored in a can or other closed container, to allow it to be applied to a surface by trowel or by brush after the can or other closed container is opened. Thereafter the mineral spirits, being highly volatile, have evaporated away, leaving behind an asphalt sealant of significantly higher viscosity than when applied. Because such asphalts have had mineral spirits blended into them, they have been referred to as “cut-backs”. Cut-back base stocks have usually been composed of about 60% asphalt and 40% mineral spirits. However, new ambient-temperature applied asphalts provided in accordance with the invention do not typically contain mineral spirits.

### SUMMARY OF THE INVENTION

The invention provides compositions for and methods of making asphalt compositions. The asphalt compositions are produced by blending lube stock, and carefully selected combinations of gelling agents, surfactants, stabilizers, thixotropic agents such as fibers, and/or other components in various quantities with asphalt in a carefully-controlled process to produce new mid-temperature and ambient-temperature applied asphalt compositions having a number of superior qualities. The lube stock and other additives are chosen to control viscosity in the asphalt without the requirement for oxidation or mineral spirits. Asphalt compositions according to the invention provide waterproofing, sealing, and weathering qualities, without requirement for oxidation, mineral spirits, or heating to extremely high temperatures prior to application. For example, mid-temperature applied asphalts are provided which may be heated at the worksite to, and applied at, temperatures of 150 to 275 degrees F. These temperatures represent considerable improvements over the 500 degree F. temperatures commonly required for working with and applying traditional hot mopping grade asphalts.

Thus the invention provides, among other advantages, reduced monetary and energy costs, and reduced risks to the environment and to persons and other creatures in the production, handling, and application of superior asphalts. Annual expenditures for fuels, additives, environmental cleanup and protection, and for the protection and cure of injured workers in the production and use of such asphalts can be significantly reduced, while providing greatly improved asphalt compositions.

Among the challenges encountered and overcome by the inventor in providing such asphalts are the need to find additives that are not destroyed at the temperatures required for mixing and applying the asphalt; the need to identify gelling agents that keep the additives in suspension at mixing and application temperatures; suitable combinations of additives to provide acceptable sag resistance, ductility, and other properties; the need to create an asphalt having adequate application viscosities at greatly reduced temperatures; and the need to provide convenient and effective packaging for such asphalts. Compositions and methods according to the invention were developed during a painstaking and exacting course of experimentation, in which combinations exhibiting a number of unexpected qualities were produced.

The invention also provides compositions for improved ambient temperature applied coatings and mastics, without the use of mineral spirits. Through the addition of carefully selected combinations of lube stock, gelling agents, surfactant, stabilizers, thixotropic agents, and other components in various quantities to an unoxidized asphalt, ambient-temperature applied asphalts having a number of superior qualities are provided.

In addition, the invention provides a method for formulating coating and mastic compounds for roofing and waterproofing by completely eliminating mineral spirits and/or minimizing the use of mineral spirits, depending on the formulator's goals. The combination and concentration of lube stock together with other additives, including for example those discussed above, can be used to control the sag and viscosity of the improved asphalts.

Thus the invention provides ambient applied asphalts produceable at reduced monetary and energy costs.

A principal ingredient used to make viscosity changes in the mid-temperature applied asphalts and ambient-temperature applied asphalts of the present invention is a suitable lube stock. Such lube stock may be virgin, i.e., newly produced, or made from recycled oils. Benefits of using lube stock include the following:
It costs significantly less than mineral spirits.
Flash points may be increased significantly to over 200 degrees F., approximately 100 degrees F. above that of mineral spirits. The flash point also depends on the other additives in the completed asphalt composition.
It is not released into the atmosphere, thereby reducing environmental damage. This is especially significant, as millions of gallons of mineral spirits are released into the air each year from cut-backs.
It remains in the asphalt, instead of evaporating, and enhances its performance:
   The asphalt retains greater flexibility
   The life expectancy of the asphalt is increased
   The asphalt is more self healing from the brutal daily expansion and contraction cycles suffered by roofs (24 hour temperature changes on a black roof surface can reach ranges of 100 degrees F.; for example, the temperature on hot and sunny summer day can reach 185 to 200 degrees F., and at night can be 85 degrees F. or lower).
It reduces need for new petroleum products, as well as making use of an otherwise hazardous waste as a valuable resource.

Aspects of the invention also include methods of preparing the improved asphalt compositions. Methods according to the invention include mixing unoxidized or oxidized asphalt with lube stock and one or more gelling agents, such as attapulgite and/or other clays, and optionally with limestone flour or other organic or synthetic fillers, which may serve as stabilizers in keeping other additives satisfactorily dispersed throughout the finished compositions; one or more surfactants, such as acetates or other ether amines; and with a variety of fillers and thixotropic agents such as cellulose or other fibers, polyolefin fibers such as polypropylene, nylon, acrylic, and polyester, and mineral wool, which helps control sag resistance and other properties, in a shearing mixer at a temperature high enough to provide substantially uniform dispersion of each of the mixed ingredients into the completed composition. Suitable temperatures are found to be within about the 150 to 275 degree F. range, and in some circumstances advantageously about 200 degrees F.

Lube stocks include long chain (20 to 50 carbon atoms) alkanes, cycloalkanes, and aromatics generally refined from crude oil. Traditionally, lube stocks have been used for making motor oil, grease and other lubricants. Lube stocks resemble motor oil. The lube stocks used in the present invention can be virgin or recycled. It may be advantageous to heat lube stock in order to reduce moisture, particularly when using recycled lube stocks. Before using the lube stock, the flash point of the particular lube stock should be checked. The flash point of virgin lube stock is usually about 350 to 400 degrees F. The flash point of recycled lube stock can vary. Generally, the higher the flash point of the lube stock the better, as it is less dangerous to use. For the mid temperature applied asphalts of the present invention, the flash point of the lube stock should be within the range of about 100 to 400 degrees F. Similarly, for the ambient-temperature applied asphalts of the present invention, lube stocks having flash points within the range of about 100 to 400 degrees F. can be used.

As described above, ingredients use in making mid-temperature applied and ambient-temperature applied asphalt compositions in accordance with the invention may be blended in single or multiple mixers. For example, compositions according to the invention may be blended by introducing a portion, such as for example about one-half, of a base asphalt, which may be unoxidized, at about 150 to 275 degrees F., into a shearing mixer, with a lube stock and optionally a gelling clay and/or a surfactant, and mixing to form a gel. Some surfactants undergo some degree of degradation at high temperatures, therefore it may be advantageous to choose the blending temperature and time of blending carefully to avoid substantial degradation. The resultant asphaltic gel can be blended with thixotropic agents such as any cellulose fiber and mineral wool to achieve a substantially uniform dispersion. In a separate mixer, the remainder of the asphalt with the limestone or other mineral flour (or other stabilizer) can blended at a final mixing temperature of about 350-400 degrees F. If the limestone flour or other mineral flour is at room temperature prior to mixing, the initial temperature may need to be higher in order to achieve a final desired mixing temperature. The contents of the two mixers can then be mixed together. The formation of the gel helps to prevent the limestone flour from settling out, e.g., falling to the bottom of the mixer. The addition of the limestone flour helps, for example, to prevent dripping or running of the asphalt after it has been applied. The asphalt can then be mixed until a substantially uniform dispersion has been achieved, and a stable asphalt composition that may be applied at greatly reduced temperatures relative to prior art compositions results. Such asphalt compositions exhibit superior sag resistance, adhesion, and sealing and waterproofing qualities. Although mixing temperature ranges have been provided, it is to be understood that the temperatures can vary widely as is known to those skilled in the art. It has been found that desirable temperatures of the compositions at the end of the mixing process can be in the range of 275 F, and sometimes preferably lower.

Mixing the composition initially in separate batches, at optionally different temperatures, as described, can be used as a way of preventing or controlling degradation of additives such as breakdown of any cellulose or surfactants, and to produce a finished composition at a temperature at which the composition may be packaged in consumable sheet material as described herein.

It should be noted that exact formulations of compositions according to the invention may depend upon the characteristics of the asphalt used. The characteristics of asphalts sometimes vary, depending upon, for example, their source. Thus it may be necessary, for example, to vary the amounts of thixotropic and gelling agents to ensure that suitable sag resistance and application viscosities are provided in the finished composition.

Asphalts according to the invention may also comprise other additives for providing or improving various qualities of the asphalts. For example, asphalts according to the invention may comprise fire retardants such as aluminum trihydrate, colorings and other components for example odor-masking compositions, such as High Temperature Fragrance product No. 83846 from Stanly S. Schoenmann, Inc., of Clark, N.J. Also, vanilla, or other aromas (for example, lilac) are available and may be incorporated into the compositions of the present invention, for example from Stanly S. Schoenmann, Inc., of Clark, N.J. Embodiments of the invention further include compositions made by such methods. In oxidized asphalts, additives are generally more problematic to add because they tend to settle out. Accordingly, the asphalts of the present invention, which can be produced using unoxidized asphalt, have a tremendous advantage.

In various aspects and embodiments the invention provides compositions, and methods of preparing them, comprising asphalts mixed with lube stocks and other ingredients in novel combinations and proportions, to achieve the unique and beneficial effects described herein.

For example, in various embodiments the invention provides compositions, and methods of preparing them, comprising about 0.25 to about 0.60 parts by weight of lube stock with about 0.40 to about 0.95 parts by weight asphalt, and optionally one or more of gelling agents, surfactants and fillers, without using rubber-like polymer modifiers. In some embodiments, it can be especially advantageous to use about 0.65 to about 0.95 parts by weight asphalt, and about 0.30 to about 0.45 parts by weight lube stock.

Additional aspects of the present invention will be apparent in view of the description which follows.

### BRIEF DESCRIPTION OF THE FIGURES

Aspects of the invention are illustrated in the figures of the accompanying drawings, which are meant to be exemplary and not limiting, and in which like references are intended to refer to like or corresponding parts.

FIG. 1 is a schematic diagram of a shearing mixer suitable for use in preparing asphalt compositions according to the invention.

FIG. 2 is a graphic representation of ratios of asphalt to lube stock in example compositions according to the invention.

### DETAILED DESCRIPTION

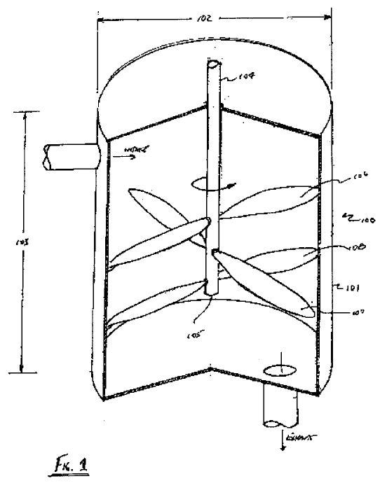

FIG. 1 is a schematic diagram of a shearing mixer suitable for use in preparing asphalt compositions according to the invention. It has been found that, in preparing compositions according to the invention, it is possible to achieve suitable dispersion, or mixing, of the asphalt with gelling agents, surfactants, and/or other additives, using one or more shearing mixers 100 capable of approximately one hundred revolutions per minute (RPM). Such a mixer may be fabricated, for example, from a vertical cylindrical tank 101 of approximately 1000 gallons' capacity, having a diameter 102 of approximately eight feet and a height 103 of approximately 9 feet, with a power driven shaft 104 descending from the top of the tank to a point 105 just above the bottom of the tank. It has been found that an electric motor of approximately horsepower output with a gear box producing approximately 100 RPM on the power shaft will serve. Attached to the shaft may be disposed several sets of shearing blades, spaced at approximately equal intervals along the shaft. A shaft comprising three sets of such blades, each set consisting of two blades disposed horizontally on opposite sides of the shaft, with the top set of blades 106 disposed about four feet below the top of the tank and the and lowest set 107 disposed about three feet from the bottom of the tank has produced satisfactory results.

Using a mixer of these dimensions permits the preparation of about 10,000 pounds of asphalt compositions according to the invention.

It has been found that introducing asphalt to the mixer in the amounts and at the temperatures described herein, and adding the various additives from the top of the tank at ambient temperatures while the mixer is operating, will produce satisfactory dispersion of all components. Mixing times of approximately 15-30 minutes have produced substantially homogenous or uniform dispersions. A substantially homogeneous dispersion in this context means a dispersion providing a substantially uniform color and blending of the asphalt and any additives, sufficiently blended to serve the purposes described herein.

In some circumstances, it has, as described above, been found advantageous to prepare compositions according to the invention in two mixers, using a first mixer to build a gel comprising the asphalt base, lube oil stock, and a gelling agent at a first, relatively lower temperature; and a second to mix relatively hotter asphalt with fillers and other ingredients prior to combine the gel and filler mixes.

### Mid-Temperature Applied Asphalt Compositions

It has been found, by experimentation, that heating asphalt and lube stock mixtures described herein to approximately 150 to 275 degrees F. in order to mix the additional components, as described herein, provides, upon mixing, a very high-quality homogenous asphalt composition. However, as will be appreciated by those of ordinary skill in the relevant arts, heating the asphalt to any temperature significantly lower than the 400 to 500 degrees F. commonly required for oxidizing asphalt will lead to improvements in the cost of preparing the compositions, reduced energy use and pollutant creation, and reduced hazards for workers and those traveling in proximity to hot product. Thus, asphalt compositions according to the invention may be prepared at any temperatures significantly lower than about 500 degrees F. For example, the invention may be advantageously practiced by heating the asphalt to about 275 degrees F., or lower.

Mixing methods of the type described, using equipment of the type described, represent substantial improvements over prior art processes for preparing hot temperature applied asphalts, many of which have required mixing using specialized, and generally expensive and relatively inefficient, high-speed mixing or grinding equipment, such as Siefer Trigonal wet mills or Dorr-Oliver Bitumen Homogenizers, each of which operates at 3000 RPM or more, Charlotte Colloid Mills (3600 RPM), or Myers High Shear Mixers (2000 RPM). The costs of obtaining and operating such equipment are in general much higher than those associated with mixers and processes according to the invention.

By careful and controlled experimentation using equipment of the type described herein, the compositions described in the following examples have been found to serve well as asphalts.

It has been found that the following specific components may be used to make the improved asphalt compositions according to the invention, particularly as described in the following specific examples:

For asphalt, the unoxidized asphalt available from Imperial Oil of Edmonton, Alberta may be used. Oxidized asphalt may also be used. As is known to those skilled in the art, asphalts from different geographical areas and different refineries may differ. Accordingly, asphalt should be evaluated in the laboratory prior to use. Evaluation may include viscosity measurements, softening point and flash point. The outcome of this evaluation will determine the nature of the additives and ratio of additives combined with the asphalt.

Either “virgin” (new) lube stock or lube stock made from recycled oils may be used. However, as is known to those skilled in the art, lube stocks, and in particular recycled lube stocks, from different geographical areas and different refineries may differ. Accordingly, each lube stock, and in particular recycled lube stocks, can be evaluated in the laboratory for lube value and flash point. It has been found that lube stock, and in particular recycled lube stock, can be made suitable by a modified refining process of heating the lube stock in a holding tank and evaporating and/or filtering off about 5% to 15% which would include all its moisture content plus certain light ends so as to purify the lube stock and increase its flash point. A flash point of about between 100 and 400 degrees F. was found to be suitable.

Part of the process of producing an asphalt composition is to build a gel. This is normally done by adding a gelling agent and a surfactant. As a gelling agent, Min-U-Gel G35®, available from Floridin, a division of ITC Industrials, Quincy, Fla. Min-U-Gel® G35 is an atapulgite clay, including specifically anhydrous magnesium aluminum silicate. A typical chemical analysis includes 66.1 parts by weight (“pbw”) SiO2, 11.71 pbw Al2O3, 4.02 pbw Fe2O3, 0.55 pbw TiO2, 0.99 pbw P2O5, 2.92 pbw CaO, 9.70 pbw MgO, 1.07 pbw K20, 2.57 pbw CO2, 0.25 pbw SO4, and a specific gravity of approximately 2.4 grams per milliliter.

As a surfactant, PA 14, available from Tomah Products, Inc., of Milton, Wis. PA 14 is a 100% cationic amine salt of the primary ether amine family, specifically isodecyloxypropylamine acetate may be used.

As a filler and stabilizer, 40-mesh limestone flour available from Hemphill Brothers, Seattle, Wash. may be used. This includes ground limestone, or calcitic lime. In general, any ground stone (i.e., flour) comprising about 80 percent or more by weight of at least one of calcium carbonate and magnesium carbonate will serve.

As a filler and thixotropic agent, cellulose fiber such as Interfibe 230, a coarse-milled cellulose fiber having an average fiber diameter of approximately 40 microns, available from Interfibe Corporation of Portage, Mich. may be used.

As a filler and thixotropic agent, polyolefin fibers, including Short Stuff® fibrillated polypropylene fibers, product no. SS-03, formula —{CH2—CH(CH3)}-n, available from MiniFibers, Inc., Johnson City, Tenn. may be used.

As a filler and thixotropic agent, MG 615-Roxul 1000 rock or mineral wool from AKZO Nobel Surface Company, Straford, Conn. In general, it is expected that any glass made from molten slag, rock, glass or combination of, these ingredients, of characteristics otherwise similar to MG 615, will serve.

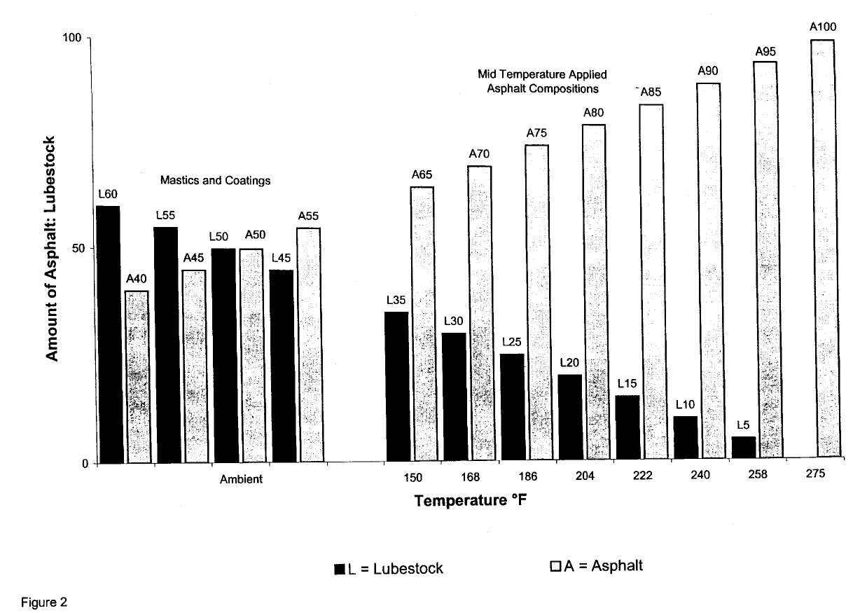

Example compositions for mid-temperature applied asphalts are listed in Table 1. There are 8 examples ranging in application temperature of 150 F to 275 F. All the compositions listed are free of mineral spirits. The application viscosity is principally adjusted by adjusting the asphalt:lube ratio, wherein the greater the ratio, the higher the application viscosity. FIG. 2 provides a graphic representation of the effect of the ratio of asphalt to lube stock and application temperature. For example, a composition having ratio of asphalt:lube of 65:35 provides a composition with an application temperature in the range of 150 F. In contrast, a composition having an asphalt:lube ratio of 95:5 results provides a composition with an application temperature of in the range of 250 F.

The compositions of examples 1 to 8 list specific surfactants, gelling agents, stabilizers, fillers and thixotropic agents, however, it is to be understood that substitutions can be made and are within the scope of the invention, as are changes in the ratio of these additives. Further, the ratio of lube stock to asphalt can be changed with different additives and/or different concentrations of additives. A worker skilled in the art and science will understand that certain additives increase the viscosity while other additives decrease the viscosity. A surfactant provides the means for the formation of a gel. A mineral flour stabilizes the asphalt so that it will not drip or run after installation. Exemplary fillers include cellulose and rock wool.

Each of the example compositions can be blended in the laboratory by introducing approximately one half of the asphalt at about 150 to 275 degrees F. into a shearing mixer, with the gelling clay and any surfactant, and mixing to form an asphaltic gel; blending the asphaltic gel with thixotropic agents such as any cellulose fiber and mineral wool to achieve a substantially uniform dispersion; blending in a separate mixer the remainder of the asphalt flux at about 350 to 400 degrees F. with the limestone or other mineral flour; and then mixing the contents of the two mixers.

Preparing any of the example compositions by the methods described herein can result in approximately 10,000 lbs. of superior mid-temperature applied asphalt composition, having a viscosity suitable for application at about 150 to 275 degrees F.

### Ambient-Temperature Applied Asphalt Compositions

Ambient-temperature applied asphalt compositions (including coatings and mastics) according to the invention can be prepared in a manner similar to that use to prepare the mid-temperature applied compositions. The present compositions eliminate or reduce the need to add mineral spirits, thus providing a cost savings. Further, the method uses a waste product (recycled lube stock) as a raw material thus reducing environmental contamination.

Example compositions for ambient-temperature applied asphalts are listed in Table 2. There are 12 examples (examples 9 to 20). All the compositions listed are free of mineral spirits. The viscosity is principally adjusted by adjusting the asphalt:lube ratio, wherein a higher asphalt:lube ratio results in a more viscous composition. For example, a composition having ratio of asphalt:lube of 55:45 provides a more viscous composition than a composition having a ratio of asphalt:lube of 40:60.

The compositions of examples 9 to 20 in Table 2 list specific surfactants, gelling agents, stabilizers, fillers and thixotropic agents; however, it is to be understood that substitutions can be made and are within the scope of the invention. Examples 9 to 12 on Table 2 describe formulations that may in some conditions be considered more suitable for roof and metal primers. Asphalt primers are used, for example, as a thin coat to enhance adhesion of asphalt to a roof. Examples 13 to 16 of Table 2 describe formulations that may be considered most suitable as fibered roof coatings and examples 17 to 20 of Table 2 describe formulations that may be considered most suitable as all weather mastics. Although specific formulations may be considered most suitable for certain applications, it is to be understood that they can in general be applied in any manner and are useful for a wide variety of sealing and waterproofing applications. The different roof and metal primers, fibered roof coatings and all weather mastics may also be considered relatively more or less suitable for various geographies. The ratio of lube stock to asphalt can be changed with different additives and/or different concentrations of additives. A worker skilled in the art and science will understand that certain additives increase the viscosity while other additives decrease the viscosity. A surfactant, for example PA 14, together with a gelling agent, for example Min-U-Gel, provides the means for the formation of a gel. A mineral flour stabilizes the asphalt so that it will not run or drip.

For ambient-temperature applied asphalt compositions (including for example coatings and mastics), the ratio of asphalt:lube stock ranges from 55:45 to 60:40. FIG. 2 provides a graphic representation of the ratio of asphalt:lube stock of the compositions of the present invention.

Each of the compositions provides advantages as described herein. It is noted, however, that variation of relative amounts of the various components of the compositions can produce compositions having various characteristics, some of which may offer particular advantages in particular applications.

As described in Tables 1 and 2 (in examples 1 to 20), the compositions of the present invention can be solvent free, cutback free, water free and oxidation free. However, as is known to those skilled in the art, solvents, cutbacks, water and oxidation can be added to produce asphalt compositions suitable for specific applications.

Compositions according to the invention, and in particular the compositions described in examples 1 to 20 in Tables 1 and 2, may also comprise further additives to achieve other or additional purposes. For example, fire retardant compounds such as aluminum trihydrate, and compounds intended to improve the dangerous, unlawful and/or otherwise unpleasant odors and emissions associated with asphalts compositions, may be used. Compositions according to the invention are typically not considered odorous, as the characteristic asphalt odor generally arises in asphalts at about 500 degrees F. Further, they generally do not have mineral spirit odors evaporating into the air. However, the use of the asphalts of the present invention in odor sensitive areas, such as hospitals, schools and places of worship, may require or make desirable the addition of odor- or aroma-controlling additives. For example, aroma agents producing odors associated with vanilla or other substances may be used. It is especially advantageous to add such additional additives after a gel has been achieved, as the less-viscous intermediate compositions can serve to disperse the additional additives and prevent them from settling out.

It is expected that a wide variety of other fillers and modifiers, though not part of the experiments that produced the compositions described in the examples listed in Tables 1 and 2, will also serve to provide greater bulk and sealing properties in the finished compositions. It has been found that many such fillers and modifiers may readily be added to the composition using known techniques, the original manufacturing process, or once the base asphalt composition has been prepared as described herein. For example, based on experience with other asphalt compositions, it is expected that rubber modifiers such as styrene-ethylene butadeiene-styrene (SEBS) copolymer, styrene-butylene-styrene (SBS) copolymer, and atactic polypropylene (APP) may be employed, with the advantages and using methods described in my prior U.S. Pat. No. 5,973,037 and others.

It is also understood that other synthetic and/or organic fillers may be used in combination with or in place of the described flours, rock wool, and other fillers. For example, long experience in preparing other types of asphalt compositions indicates that sand, ground slate, perlite, mica, chald, Wallastonite, wool, cotton, hemp, and diatomaceous earth can serve satisfactorily, and may be incorporated into the asphalt composition using preparation methods described herein, and/or after completion of the asphalt base. Generally, the addition of minerals acts to stabilize the asphalt composition and control dripping and running. The addition of fibers offer sag control.

While the foregoing invention has been described in some detail for purposes of clarity and understanding, it will be appreciated by one skilled in the art, from a reading of the disclosure, that various changes in form and detail can be made without departing from the true scope of the invention as described in the appended claims. The detailed description of the example embodiments is intended to be illustrative, and not limiting.

TABLE 1
Mid Temperature Applied (150 F.–275 F.) Asphalt Formulas for
Roofing & Waterproofing Application Temperature Principally
Adjusted by Asphalt:Lube Stock Ratio
Mineral Spirits Free (Not Cut-Backs)

| | | | |
|---|---|---|---|
| Application | | | |
| Temp Deg F. | RAW MATERIALS | % WGT | LBS TON |

EXAMPLE 1

| | | | |
|---|---|---|---|
| 150 | Asphalt:Lube (65:35) | 0.30280 | 605.605 |
| | Lube:Asphalt (35:65) | 0.16305 | 326.095 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

EXAMPLE 2

| | | | |
|---|---|---|---|
| 168 | Asphalt:Lube (70:30) | 0.32610 | 652.190 |
| | Lube:Asphalt (30:70) | 0.13976 | 279.510 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

EXAMPLE 3

| | | | |
|---|---|---|---|
| 186 | Asphalt:Lube (75:25) | 0.34939 | 698.775 |
| | Lube:Asphalt (25:75) | 0.11646 | 232.925 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

EXAMPLE 4

| | | | |
|---|---|---|---|
| 204 | Asphalt:Lube (80:20) | 0.37268 | 745.360 |
| | Lube:Asphalt (20:80) | 0.09317 | 186.340 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

EXAMPLE 5

| | | | |
|---|---|---|---|
| 222 | Asphalt:Lube (85:15) | 0.39597 | 791.945 |
| | Lube:Asphalt (15:85) | 0.06988 | 139.755 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

EXAMPLE 6

| | | | |
|---|---|---|---|
| 240 | Asphalt:Lube (90:10) | 0.41927 | 838.530 |
| | Lube:Asphalt (10:90) | 0.04659 | 93.170 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

EXAMPLE 7

| | | | |
|---|---|---|---|
| 258 | Asphalt:Lube (95:05) | 0.44256 | 885.115 |
| | Lube:Asphalt (05:95) | 0.02329 | 46.585 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

EXAMPLE 8

| | | | |
|---|---|---|---|
| 275 | Asphalt:Lube (100:00) | 0.46585 | 931.700 |
| | Lube:Asphalt (00:100) | 0.00000 | 0.000 |
| | PA 14 | 0.00750 | 15.000 |
| | G35 MinuGel | 0.01000 | 20.000 |
| | 230 Cellulouse | 0.01300 | 26.000 |
| | 615 Rock Wool | 0.00350 | 7.000 |
| | Vanilla Aroma | 0.00015 | 0.300 |
| | Limestone Flour | 0.50000 | 1000.000 |
| | TOTALS | 1.00000 | 2000.000 |

TABLE 2
Ambient Temperature Applied Coatings & Mastics Formulas for Roofing & Waterproofing
Viscosity Principally Adjusted by Asphalt:Lube Stock Ratio
Mineral Spirits Free (Not Cut-Backs)

| | RAW MATERIALS | % WGT | LBS TON | RAW MATERIALS | % WGT | LBS TON | |
|---|---|---|---|---|---|---|---|
| EXAMPLE 9 | | | | EXAMPLE 10 | | | |
| Roof and | Asphalt:Lube (55:45) | 0.5500 | 1100.000 | Asphalt:Lube (50:50) | 0.5000 | 1000.000 | Roof and |
| Metal | Lube:Asphalt (45:55) | 0.4500 | 900.000 | Lube:Asphalt (50:50) | 0.5000 | 1000.000 | Metal |
| Primer A | TOTALS | 1.0000 | 2000.000 | TOTALS | 1.0000 | 2000.000 | Primer B |
| EXAMPLE 11 | | | | EXAMPLE 12 | | | |
| Roof and | Asphalt:Lube (45:55) | 0.4500 | 900.000 | Asphalt:Lube (40:60) | 0.4000 | 800.000 | Roof and |
| Metal | Lube:Asphalt (55:45) | 0.5500 | 1100.000 | Lube:Asphalt (60:40) | 0.6000 | 1200.000 | Metal |
| Primer C | TOTALS | 1.0000 | 2000.000 | TOTALS | 1.0000 | 2000.000 | Primer D |
| EXAMPLE 13 | | | | EXAMPLE 14 | | | |
| Fibered | Asphalt:Lube (55:45) | 0.25622 | 512.435 | Asphalt:Lube (50:50) | 0.23293 | 465.850 | Fibered |
| Roof | Lube:Asphalt (45:55) | 0.20963 | 419.265 | Lube:Asphalt (50:50) | 0.23293 | 465.850 | Roof |
| Coating A | PA 14 | 0.00750 | 15.000 | PA 14 | 0.00750 | 15.000 | Coating B |
| | G35 MinuGel | 0.01000 | 20.000 | G35 MinuGel | 0.01000 | 20.000 | |
| | 230 Cellulouse | 0.01300 | 26.000 | 230 Cellulouse | 0.01300 | 26.000 | |
| | 615 Rock Wool | 0.00350 | 7.000 | 615 Rock Wool | 0.00350 | 7.000 | |
| | Vanilla Aroma | 0.00015 | 0.300 | Vanilla Aroma | 0.00015 | 0.300 | |
| | Limestone Flour | 0.50000 | 1000.000 | Limestone Flour | 0.50000 | 1000.000 | |
| | TOTALS | 1.00000 | 2000.000 | TOTALS | 1.00000 | 2000.000 | |
| EXAMPLE 15 | | | | EXAMPLE 16 | | | |
| Fibered | Asphalt:Lube (45:55) | 0.20963 | 419.265 | Asphalt:Lube (40:60) | 0.18634 | 372.680 | Fibered |
| Roof | Lube:Asphalt (55:45) | 0.25622 | 512.435 | Lube:Asphalt (60:40) | 0.27951 | 559.020 | Roof |
| Coating C | PA 14 | 0.00750 | 15.000 | PA 14 | 0.00750 | 15.000 | Coating D |
| | G35 MinuGel | 0.01000 | 20.000 | G35 MinuGel | 0.01000 | 20.000 | |
| | 230 Cellulouse | 0.01300 | 26.000 | 230 Cellulouse | 0.01300 | 26.000 | |
| | 615 Rock Wool | 0.00350 | 7.000 | 615 Rock Wool | 0.00350 | 7.000 | |
| | Vanilla Aroma | 0.00015 | 0.300 | Vanilla Aroma | 0.00015 | 0.300 | |
| | Limestone Flour | 0.50000 | 1000.000 | Limestone Flour | 0.50000 | 1000.000 | |
| | TOTALS | 1.00000 | 2000.000 | TOTALS | 1.00000 | 2000.000 | |
| EXAMPLE 17 | | | | EXAMPLE 18 | | | |
| All | Asphalt:Lube (55:45) | 0.25622 | 512.435 | Asphalt:Lube (50:50) | 0.23293 | 465.850 | All |
| Weather | Lube:Asphalt (45:55) | 0.20963 | 419.265 | Lube:Asphalt (50:50) | 0.23293 | 465.850 | Weather |
| Mastic A | PA 14 | 0.01000 | 20.000 | PA 14 | 0.01000 | 20.000 | Mastic B |
| | G35 MinuGel | 0.03000 | 60.000 | G35 MinuGel | 0.03000 | 60.000 | |
| | 230 Cellulouse | 0.02000 | 40.000 | 230 Cellulouse | 0.02000 | 40.000 | |
| | 615 Rock Wool | 0.01000 | 20.000 | 615 Rock Wool | 0.01000 | 20.000 | |
| | Vanilla Aroma | 0.00015 | 0.300 | Vanilla Aroma | 0.00015 | 0.300 | |
| | Limestone Flour | 0.46400 | 928.000 | Limestone Flour | 0.46400 | 928.000 | |
| | TOTALS | 1.00000 | 2000.000 | TOTALS | 1.00000 | 2000.000 | |
| EXAMPLE 19 | | | | EXAMPLE 20 | | | |
| All | Asphalt:Lube (45:55) | 0.20963 | 419.265 | Asphalt:Lube (40:60) | 0.18634 | 372.680 | All |
| Weather | Lube:Asphalt (55:45) | 0.25622 | 512.435 | Lube:Asphalt (60:40) | 0.27951 | 559.020 | Weather |
| Mastic C | PA 14 | 0.01000 | 20.000 | PA 14 | 0.01000 | 20.000 | Mastic D |
| | G35 MinuGel | 0.03000 | 60.000 | G35 MinuGel | 0.03000 | 60.000 | |
| | 230 Cellulouse | 0.02000 | 40.000 | 230 Cellulouse | 0.02000 | 40.000 | |
| | 615 Rock Wool | 0.01000 | 20.000 | 615 Rock Wool | 0.01000 | 20.000 | |
| | Vanilla Aroma | 0.00015 | 0.300 | Vanilla Aroma | 0.00015 | 0.300 | |
| | Limestone Flour | 0.46400 | 928.000 | Limestone Flour | 0.46400 | 928.000 | |
| | TOTALS | 1.00000 | 2000.000 | TOTALS | 1.00000 | 2000.000 | |

What is claimed is:

1. A method of preparing an improved asphalt composition, the method comprising:
mixing at a ratio of about 0.05 to about 0.60 parts by weight of lube stock with about 0.95 to about 0.40 parts by weight asphalt, without the addition of polymer rubber modifiers
in a shearing mixer at a temperature high enough to provide substantially uniform dispersion of each of the mixed ingredients in the improved asphalt composition.

2. The method of claim 1 further comprising adding a gelling agent, a surfactant and a filler.

3. The method of claim 1 wherein the mixing comprises about 0.45 to about 0.60 parts of lube stock with about 0.65 to about 0.40 parts of asphalt.

4. The method of claim 3 further comprising adding a gelling agent, a surfactant and a filler.

5. The method of claim 3 wherein the weight of the lube stock and asphalt at the given ratio comprises about 46% of the final weight of the improved asphalt composition, the method further comprising mixing the following ingredients with the lube stock and asphalt:
about 1% by weight gelling agent;
about 0.75% parts by weight surfactant;
about 50% by weight of a mineral flour;
about 1.3% by weight cellulose fiber;
about 0 to about 0.015% by weight aroma; and
about 0.35% by weight mineral wool
wherein the percent by weight encompasses +/−5% of the percent value and the improved asphalt composition is a fibered roof coating.

6. The method of claim 3 wherein the weight of the lube stock and asphalt at the given ratio comprises about 46% of the final weight of the improved asphalt composition, the method further comprising mixing the following ingredients with the lube stock and asphalt:
about 3% by weight gelling agent;
about 1% parts by weight surfactant;
about 46.4% by weight of a mineral flour;
about 2% by weight cellulose fiber;
about 0 to about 0.015% by weight aroma; and
about 1% by weight mineral wool
wherein the percent by weight encompasses +/−5% of the percent value and the improved asphalt composition is an all weather mastic.

7. A method of preparing a mid-temperature applied asphalt composition, the method comprising mixing at a ratio of about 0.40 to about 0.95 parts by weight asphalt with about 0.60 to about 0.05 parts by weight lube stock such that the combined weight of lube stock and asphalt is about 46% of the total weight of the mid-temperature applied asphalt composition, and further comprising mixing the following ingredients with the lube stock and asphalt:
a gelling agent, a surfactant and a filler
in one or more shearing mixers at a temperature high enough to provide substantially uniform dispersion of each of the mixed ingredients in the mid-temperature applied asphalt composition, and wherein the percent by weight encompasses +/−5% of the percent value.

8. A method of preparing a mid-temperature applied asphalt composition, the method comprising mixing at a ratio of about 0.40 to about 0.95 parts asphalt with about 0.60 to about 0.05 parts by weight lube stock such that the combined weight of lube stock and asphalt is about 46% of the total weight of the mid-temperature applied asphalt composition, and further comprising mixing the following ingredients with the lube stock and asphalt:
about 1% by weight gelling agent;
about 0.75% parts by weight surfactant;
about 50% by weight of a mineral flour;
about 1.3% by weight cellulose fiber;
about 0 to about 0.015% by weight aroma; and
about 0.35% by weight mineral wool
in one or more shearing mixers at a temperature high enough to provide substantially uniform dispersion of each of the mixed ingredients in the mid-temperature applied asphalt composition, and wherein the percent by weight encompasses +/−5% of the percent value.

9. The method of any of claim 1, wherein the temperature of the asphalt in the mixer is less than 275 degrees Fahrenheit.

10. The method of claim 6 wherein the clay comprises attapulgite clay.

11. The method of claim 11 wherein the clay is MinUGelG35.

12. The method of claim 6 wherein the surfactant is a cationic surfactant.

13. The method of claim 6 wherein the surfactant comprises an amine.

14. The method of claim 6 wherein the surfactant comprises an ether amine.

15. The method of claim 6 wherein the surfactant comprises an acetate

16. The method of claim 6 wherein the surfactant is isodecyloxypropylamine acetate.

17. The method of claim 6 wherein the surfactant is PA14.

18. The method of claim 6 wherein the mineral flour is limestone flour.

19. the method of claim 6 wherein the cellulose fiber is Interfibe 230.

20. The method of claim 6 wherein the mineral wool is MG615

21. The method of claim 6 wherein the aroma is vanilla aroma.

22. The method of claim 6 further comprising mixing the asphalt with aluminum trihydrate.

23. An improved asphalt composition prepared according to the method of claims 1 to 23.

24. The composition of claim 24 further comprising aluminum trihydrate.

25. An improved asphalt composition comprising,
a ratio of about 0.05 to about 0.60 parts by weight lube stock with about 0.95 to about 0.40 parts by weight asphalt, without the addition of polymer rubber modifiers.

26. The improved asphalt composition of claim 26 further comprising a gelling agent, a surfactant and a filler.

27. An ambient-temperature applied asphalt composition comprising:
about 0.40 to 55% by weight asphalt; and
about 45 to 60% by weight lube stock without the addition of polymer rubber modifiers, and wherein the percent by weight encompasses +/−5% of the percent value.

28. The composition of claim 28 wherein the composition is a primer.

29. An ambient temperature applied asphalt composition comprising
about 17 to about 27% by weight asphalt;
about 19 to about 29% by weight lube stock;
about 1% by weight gelling agent;
about 0.75% by weight surfactant;
about 50% by weight of a mineral flour;
about 1.3% by weight cellulose fiber;
about 0 to about 0.015% by weight aroma; and
about 0.35% by weight mineral wool,
wherein the percent by weight encompasses +/−5% of the percent value.

30. The composition of claim 30 wherein the composition is a fibered roof coating.

31. An ambient temperature applied asphalt composition comprising
about 17 to about 27% by weight asphalt;
about 19 to about 29% by weight lube stock;
about 3% by weight gelling agent;
about 1% by weight surfactant;
about 46.4% by weight of a mineral flour;
about 2% by weight cellulose fiber;
about 0 to about 0.015% by weight aroma; and
about 1% by weight mineral wool,
wherein the percent by weight encompasses +/−5% of the percent value.

32. The composition of claim 32 wherein the asphalt is an all weather mastic.

33. A mid-temperature applied asphalt composition comprising,
about 65 to about 95% by weight asphalt;
about to 0.05% to about 35% by weight lube stock;
about 1% by weight gelling agent;
about 0.75% by weight surfactant;
about 50% by weight of a mineral flour comprising at least 80 percent by weight of at least one of calcium carbonate and magnesium carbonate;
about 1.3% by weight cellulose fiber;
about 0 to about 0.015% by weight aroma; and
about 0.35% by weight mineral wool,
wherein the percent by weight encompasses +/−5% of the percent value.

34. The composition of claim 26 further comprising aluminum trihydrate.

35. A method of reconditioning recycled lube stock so that is suitable for use in an asphalt composition, the method comprising:
(i) heating recycled lube stock;
(ii) filtering off about 5% to about 15% of the lube stock
wherein essentially all moisture and light ends are filtered off so as to re-condition the lube stock and increase its flashpoint.

36. The methods of any of claim 1 wherein the lube stock is reconditioned according to claim 36.
